(19) United States
(12) Patent Application Publication
(10) Pub. No.: US 2020/0259608 A1
(43) Pub. Date: Aug. 13, 2020

(54) METHOD FOR WIRELESS COMMUNICATION

(71) Applicants: NTT DOCOMO, INC., Tokyo (JP); DOCOMO, INNOVATIONS, INC., Palo Alto, CA (US)

(72) Inventors: Yuichi Kakishima, Tokyo (JP); Chongning Na, Tokyo (JP); Satoshi Nagata, Tokyo (JP)

(73) Assignee: NTT DOCOMO, INC., Tokyo (JP)

(21) Appl. No.: 16/637,520

(22) PCT Filed: Aug. 8, 2018
(86) PCT No.: PCT/US2018/045707

§ 371 Date: Feb. 7, 2020

Related U.S. Application Data
(60) Provisional application No. 62/542,649, filed on Aug. 8, 2017.

(51) Int. Cl. H04L 5/00; H04B 7/06; H04W 24/10; H04L 1/00

(52) U.S. Cl. CPC H04L 5/0048; H04B 7/0626; H04L 1/0026; H04W 24/10; H04B 7/0632

(57) ABSTRACT

A method for wireless communication includes transmitting, from a base station (BS) to a user equipment (UE), multiple Channel State Information Reference Signals (CSI-RSs) multiplexed on different subbands, selecting, with the UE, a predetermined subband of the different subbands based on reception quality of the multiple CSI-RSs, and transmitting, form the UE to the BS, information indicating the predetermined subband. The method further includes transmitting, from the BS to the UE, a CSI-RS multiplexed on the predetermined subband and transmitting, from the UE to the BS, CSI feedback based on the CSI-RS multiplexed on the predetermined subband.

### TECHNICAL FIELD

One or more embodiments disclosed herein relate to a method for wireless communication in a wireless communication system that includes a user equipment and a base station.

### BACKGROUND

A New Radio (NR; fifth generation (5G) radio access technology) system operates in higher frequency bands (e.g., Millimeter Wave (mmWave)). In the NR system using the mmWave, transmission and reception beam selection greatly affects system characteristics.

In the NR system, transmission and reception beams are determined using a beam management scheme and a channel state information (CSI) acquisition scheme. Typically, a long-term (periodic) and wideband beam may be determined in the beam management scheme, and then, a short-term (triggered) and narrow band beam may be determined in the CSI acquisition scheme.

In the CSI acquisition scheme in NR technologies, a beam determination method using Chanel State Information Reference Signals (CSI-RSs) multiplexed on partial band (subband CSI-RS) has been studied.

In order to efficiently determine a transmission bandwidth for the subband CSI-RS used in the CSI acquisition scheme, preliminary information to schedule subband CSI-RS (e.g., subband that achieves better link quality) may be required. In view of the above, it may be beneficial to acquire the preliminary information (subband scheduling information) before the subband CSI-RS transmission in the CSI acquisition scheme.

However, in the current beam management scheme in the NR technologies, a method to acquire the subband scheduling information before the subband CSI-RS transmission in the CSI acquisition scheme has not been determined.

### CITATION LIST

### Non-Patent Reference

[Non-Patent Reference 1] 3GPP, TS 36.211 V 14.3.0
[Non-Patent Reference 2] 3 GPP, TS 36.213 V14.3.0

### SUMMARY

One or more embodiments of the present invention relate to a method for wireless communication that includes transmitting, from a base station (BS) to a user equipment (UE), multiple Channel State Information Reference Signals (CSI-RSs) multiplexed on different subbands, selecting, with the UE, a predetermined subband of the different subbands based on reception quality of the multiple CSI-RSs, and transmitting, form the UE to the BS, information indicating the predetermined subband.

One or more embodiments of the present invention relate to a method for wireless communication that includes transmitting, from a B) to a UE, multiple CSI-RSs. Each of the multiple CSI RSs may be multiplexed on a wideband that includes a plurality of subbands. The method further includes measuring, with the UE, reception quality of the multiple CSI-RSs in each of the plurality of subbands, selecting, with the UE, a predetermined subband of the plurality of subbands based on the reception quality, and transmitting, form the UE to the BS, information indicating the predetermined subband.

One or more embodiments of the present invention relate to a method for wireless communication that includes transmitting, from a BS to a UE, multiple CSI-RSs using different beams. Each of the multiple CSI-RSs is multiplexed on a wideband that includes a plurality of subbands. The method further includes measuring, with the UE, reception quality of the multiple CSI-RSs in each of the plurality of subbands, determining, with the UE, a predetermined beam of the different beams in each of the plurality of subbands based on the reception quality, and transmitting, form the UE to the BS, information indicating the predetermined beam in each of the plurality of subband.

One or more embodiments of the present invention can provide a method to determine an appropriate subband used for a subband CSI-RS transmission in a CSI acquisition scheme.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIG. 2A is a diagram showing an example of a resource configuration of a wideband CSI-RS according to one or more embodiments of the present invention.

FIG. 2B is a diagram showing an example of a resource configuration of a subband CSI-RS according to one or more embodiments of the present invention.

FIG. 3 is a flowchart diagram showing an overview example of operations of beam management and CSI acquisition schemes according to one or more embodiments of the present invention.

FIG. 4 is a diagram to explain RS transmission with beam sweeping according to one or more embodiments of the present invention.

FIG. 5 is a sequence diagram showing an operation example of beam management and CSI acquisition schemes according to one or more embodiments of a first example of the present invention.

FIGS. 6A and 6B are diagrams showing examples of a resource configuration of multiple subband CSI-RSs in a beam management scheme according to one or more embodiments of a first example of the present invention.

FIG. 7 is a sequence diagram showing an operation example of beam management and CSI acquisition schemes according to one or more embodiments of a second example of the present invention.

FIGS. 8A and 8B are diagrams to explain reception quality measurement according to one or more embodiments of the second example of the present invention.

FIG. 9 is a sequence diagram showing an operation example of beam management and CSI acquisition schemes according to one or more embodiments of a second modified example of the present invention.

FIG. 10 is a table showing a method of selecting beam based on RSRP of a subband according to one or more embodiments of an another example of the second modified example of the present invention.

FIG. 11 is a sequence diagram showing an operation example of beam management and CSI acquisition schemes according to one or more embodiments of a third example of the present invention.

FIG. 12 is a table showing a method of selecting a beam in each subband according to one or more embodiments of the third example of the present invention.

FIGS. 13A and B are tables showing feedback information according to one or more embodiments of the third example of the present invention.

FIG. 14 is a sequence diagram showing an operation example of beam management and CSI acquisition schemes according to one or more embodiments of a third modified example of the present invention.

FIG. 15 is a table showing feedback information according to one or more embodiments of the third modified example of the present invention.

FIG. 16 is a diagram showing a schematic configuration of the gNB according to one or more embodiments of the present invention.

FIG. 17 is a diagram showing a schematic configuration of the UE according to one or more embodiments of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

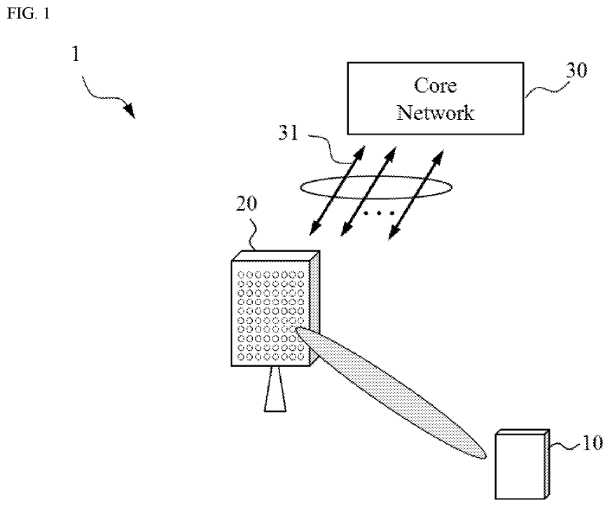

FIG. 1 is a wireless communications system 1 according to one or more embodiments of the present invention. The wireless communication system 1 includes a user equipment (UE) 10, a gNodeB (gNB) 20, and a core network 30. The wireless communication system 1 may be a New Radio (NR) system. The wireless communication system 1 is not limited to the specific configurations described herein and may be any type of wireless communication system such as an LTE/LTE-Advanced (LTE-A) system.

The gNB 20 may communicate uplink (UL) and downlink (DL) signals with the UE 10 in a cell of the gNB 20. The DL and UL signals may include control information and user data. The gNB 20 may communicate DL and UL signals with the core network 30 through backhaul links 31. The gNB 20 may be an example of a base station (BS). The gNB 20 may be referred to as a transmission and reception point (TRP). For example, when the wireless communications system 1 is a LTE system, the BS may be an evolved NodeB (eNB).

The gNB 20 includes antennas, a communication interface to communicate with an adjacent gNB 20 (for example, X2 interface), a communication interface to communicate with the core network 30 (for example, S1 interface), and a CPU (Central Processing Unit) such as a processor or a circuit to process transmitted and received signals with the UE 10. Operations of the gNB 20 may be implemented by the processor processing or executing data and programs stored in a memory. However, the gNB 20 is not limited to the hardware configuration set forth above and may be realized by other appropriate hardware configurations as understood by those of ordinary skill in the art. Numerous gNBs 20 may be disposed so as to cover a broader service area of the wireless communication system 1.

The UE 10 may communicate DL and UL signals that include control information and user data with the gNB 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the gNB 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

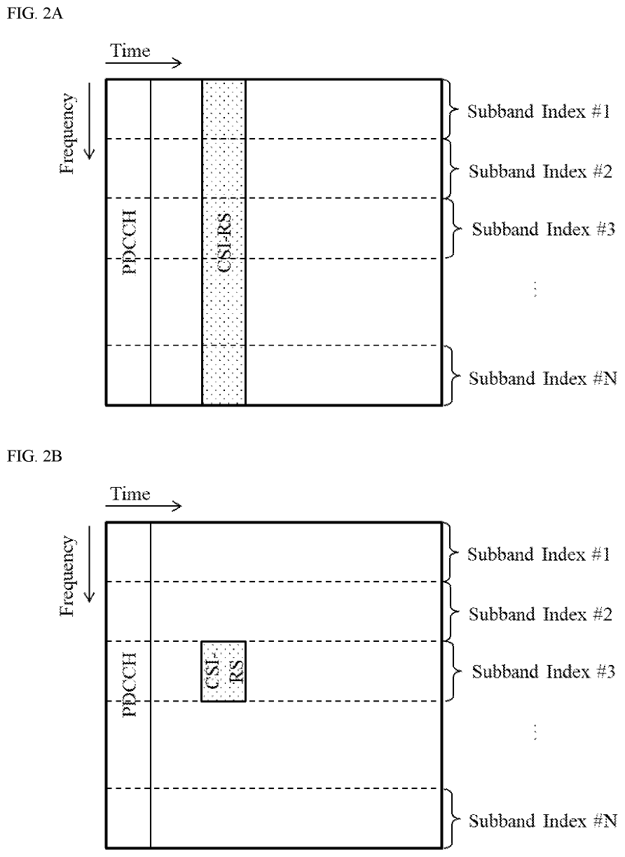

In one or more embodiments of the present invention, as shown in FIG. 2A, a wideband CSI-RS may be multiplexed on all frequency resources (e.g., carrier bandwidth, system bandwidth or bandwidth part) in a frequency domain.

In one or more embodiments of the present invention, as shown in FIG. 2B, a subband CSI-RS may be multiplexed on partial frequency resources (subband) in the frequency domain. In an example of FIG. 2B, the subband CSI-RS is multiplexed on the subband of a subband index #3. The number of subbands allocated to the subband CSI-RS is not limited to one (e.g., subband index #3). In one more embodiments of the present invention, the subband CSI-RS may be multiple subbands such as subbands of subband indexes #1 and #3 or subband indexes #2 and #3. The subbands allocated to the CSI-RS may be a continuous bandwidth or a non-contiguous bandwidth. For example, the subbands allocated to the CSI-RS may be hopped in a frequency domain. In one or more embodiments of the present invention, the subband used for the CSI-RS transmission may be different from the subband selected in the UE 10 (included in the feedback information from the UE 10 to the gNB 20). For example, the CSI-RS transmission bandwidth may not be configured as a subband unit used for feedback of the selected subband.

In one or more embodiments of the present invention, the subband may be referred to as a subband associated with a subband index, a component carrier (cell), bandwidth part, or partial band. The subband according to one or more embodiments of the present invention may be a subband group including a plurality of subbands or a group including a plurality of component carriers (cells), bandwidth parts, or partial bands.

In one or more embodiments of the present invention, the subband may be referred to as a subband associated with a subband index, a component carrier (cell), bandwidth part, or partial band. The subband according to one or more embodiments of the present invention may be a subband group including a plurality of subbands or a group including a plurality of component carriers (cells), bandwidth parts, or partial bands.

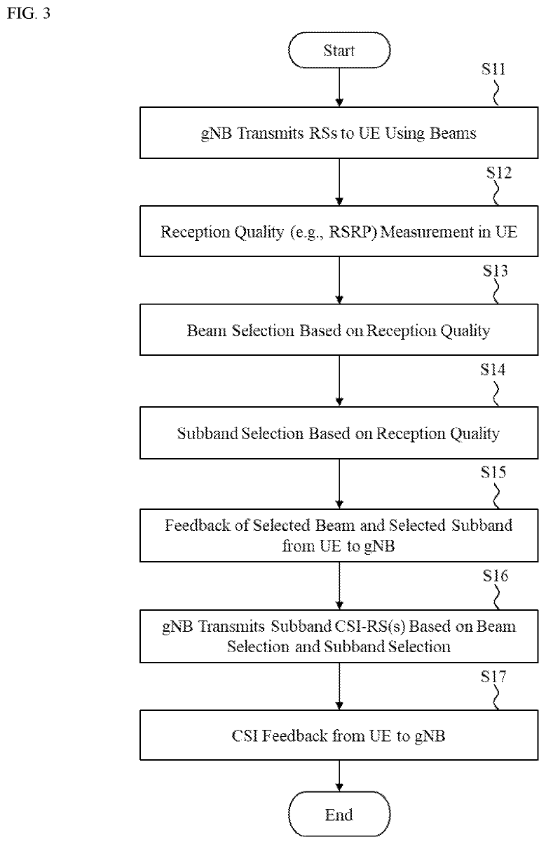

An overview of operations in the wireless communication system 1 according to one or more embodiments of the present invention will be described below, with respect to FIG. 3.

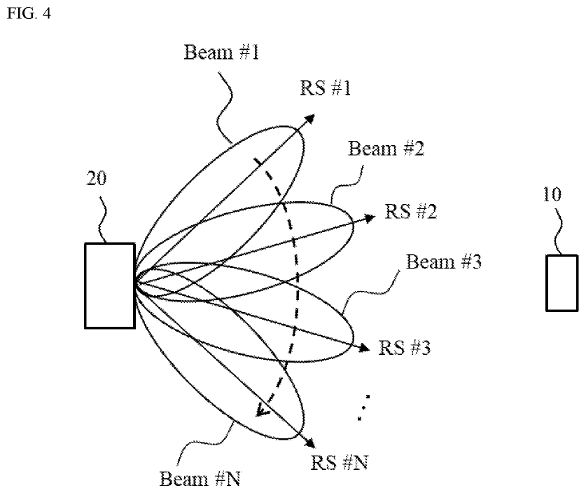

At step S11, the gNB 20 may transmit reference signals (RSs) using beams (beamformed RSs) to the UE 10. For example, at the step S11, as shown in FIG. 4, the gNB 20 may transmit RSs #1, #2, #3, . . . , and # N using beams #1, #2, #3, . . . , and # N, respectively, with beam sweeping. Each of the beams is associated with a beam index. That is, the RS transmitted using the beam is associated. The RS may be the CSI-RS or other predetermined downlink signal.

As step S12 in FIG. 3, the UE 10 may measure reception quality of each of the RSs associated with the beam. The reception quality may be Reference Signal Received Power (RSRP), RSRQ (Reference Signal Received Quality), and Received Signal Strength Indicator (RSSI).

At step S13, the beam selection may be performed based on the reception quality. For example, the UE 10 may perform the beam selection and transmit feedback information indicating the selected beam (beam index) to the gNB 20.

At step S14, the subband selection may be performed based on the reception quality (e.g., RSRP). For example, the UE 10 may perform the subband selection based on the RSRP.

At step S15, the UE 20 may transmit feedback information indicating the selected beam and the selected subband (subband index) to the gNB 20.

In the beam management scheme according to one or more embodiments of the present invention, the subband selection at the step S14 and the feedback of the selected subband at the step S15 in addition to the operations at the steps S11-S13 may be performed.

In the CSI acquisition scheme, at step S16, the gNB 20 may transmit, to the UE 10, a subband CSI-RS (or subband CSI-RSs) multiplexed on the selected subband using the selected beam.

At step S17, the UE 10 may transmit CSI feedback to the gNB 20 in response to the subband CSI-RS.

Thus, according to one or more embodiments of the present invention, an appropriate subband used for a subband CSI-RS transmission in the CSI acquisition scheme can be determined based on the subband selection in the beam management scheme.

As another example, at step S13, the UE 10 may transmit, to the gNB 20, feedback information indicating the reception quality of each of the RSs associated with the beam index. Then, gNB 20 may perform the beam selection based on the received feedback information.

As another example, at step S14, the UE 10 may transmit, to the gNB 20, feedback information indicating the reception quality of subbands in the RSs. Then, gNB 20 may perform the subband selection based on the received feedback information.

Furthermore, the beam management scheme according to one more embodiments of the present invention may be a method of determining a beam based on the reception quality such as RSRP.

### First Example

According to one or more embodiments of a first example of the present invention, subband RSs may be transmitted in the beam management scheme and a subband allocated to a subband CSI-RS in the CSI acquisition scheme may be selected based on the subband RSs in the beam management scheme.

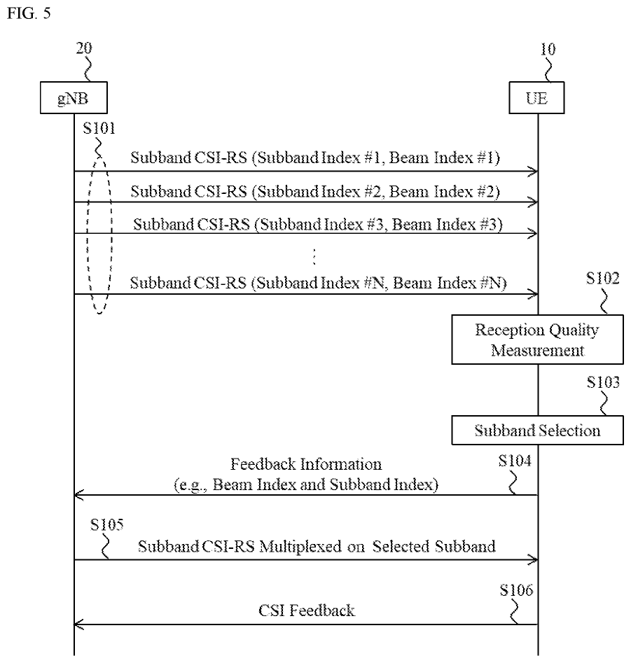

FIG. 5 is a sequence diagram showing an operation example of beam management and CSI acquisition schemes according to one or more embodiments of the first example of the present invention.

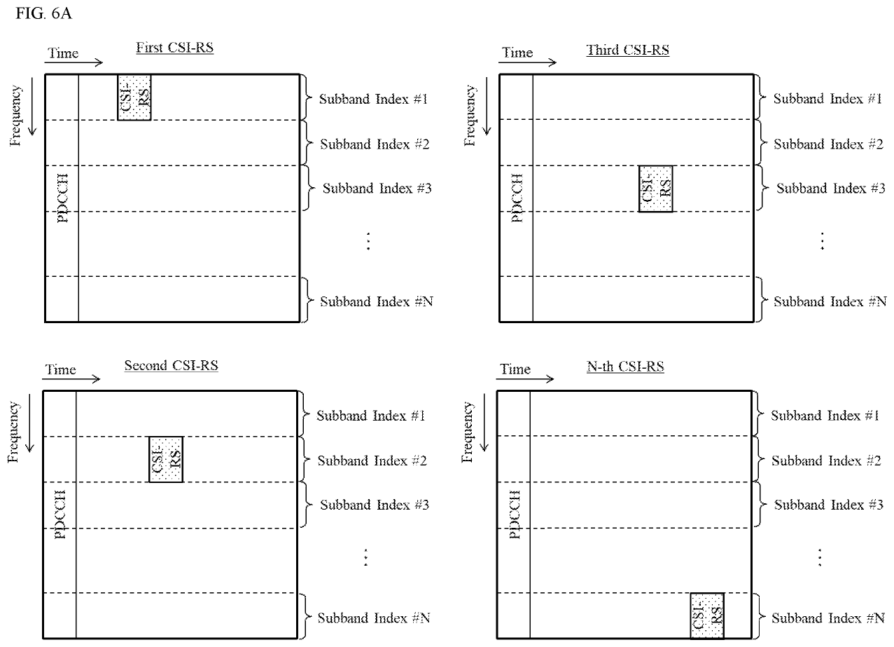

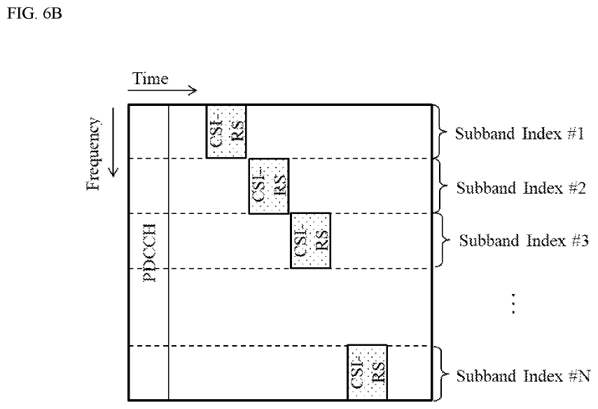

As shown in FIG. 5, at step S101, the gNB 20 may transmit multiple subband CSI-RSs to the UE 10. The subband CSI-RS is an example of a predetermined RS multiplexed on partial frequency resources as shown in FIG. 2B. FIGS. 6A and 6B are diagrams of examples of resource configurations of the multiple subband CSI-RSs at the step S101 in FIG. 5. As shown in FIGS. 5 and 6A and 6B, the first, second, third, . . . , and N-th CSI-RSs may be multiplexed on the subbands of subband indexes #1, #2, #3, . . . , and # N, respectively. The multiple subband CSI-RSs may be sequentially transmitted in a time-domain. In FIG. 6A, each of the CSI-RSs may be transmitted using a different resource. In FIG. 6B, each of the CSI-RSs may be transmitted using the same resource.

Then, the UE 10 receives the multiple subband CSI-RSs. At step S102, the UE 10 may measure reception quality of the multiple subband CSI-RSs.

At step S103, the UE 10 may select, from the subbands (subband indexes #1-# N) allocated to the multiple subband CSI-RSs, the subband (e.g., subband index #1) allocated to the subband CSI-RS having the best reception quality. Furthermore, the UE 10 may select the best-M reception quality of the M subbands CSI-RSs and select the M subbands allocated to the M subband CSI-RSs.

At step S104, the UE 10 may transmit feedback information to the gNB 20. For example, the feedback information may include the selected subband index (e.g., subband index #1) and the beam index corresponding to the selected subband. The feedback information may further include at least one of the reception quality (e.g., RSRP) of the selected subband.

In the CSI acquisition scheme, at step S105, the gNB 20 may transmit a subband CSI-RS multiplexed on the selected subband (e.g., subband index #1) to the UE 10.

When the UE 10 receives the subband CSI-RS, the UE 10 may perform the CSI calculation based on the subband CSI-RS. At step S106, the UE 10 may transmit CSI feedback based on the calculated CSI. The CSI feedback includes at least one of a Rank Indicator (RI), a CSI-RS resource indicator (CRI), a Precoding Matrix Indicator (PMI), a Channel Quality Indicator (CQI), and the RSRP.

Thus, according to one or more embodiments of the first example of the present invention, the subband allocated to the subband CSI-RS in the CSI acquisition scheme can be properly determined by transmitting the multiple subband CSI-RSs from the gNB 20 to the UE 10 and measuring the reception quality of the multiple subband CSI-RSs.

### Second Example

According to one or more embodiments of a second example of the present invention, wideband RSs may be transmitted in the beam management scheme and a subband allocated to a subband CSI-RS in the CSI acquisition scheme may be selected based on the wideband RSs in the beam management scheme.

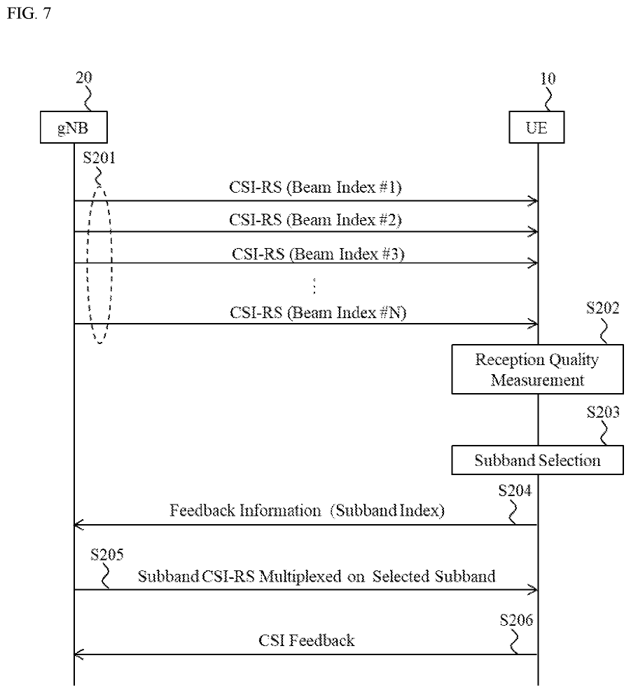

FIG. 7 is a sequence diagram showing an operation example of beam management and CSI acquisition schemes according to one or more embodiments of the second example of the present invention.

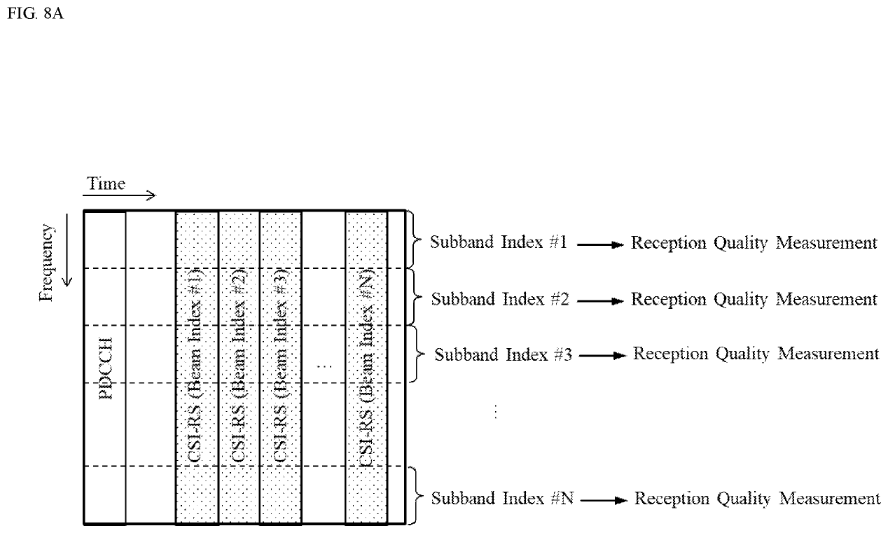

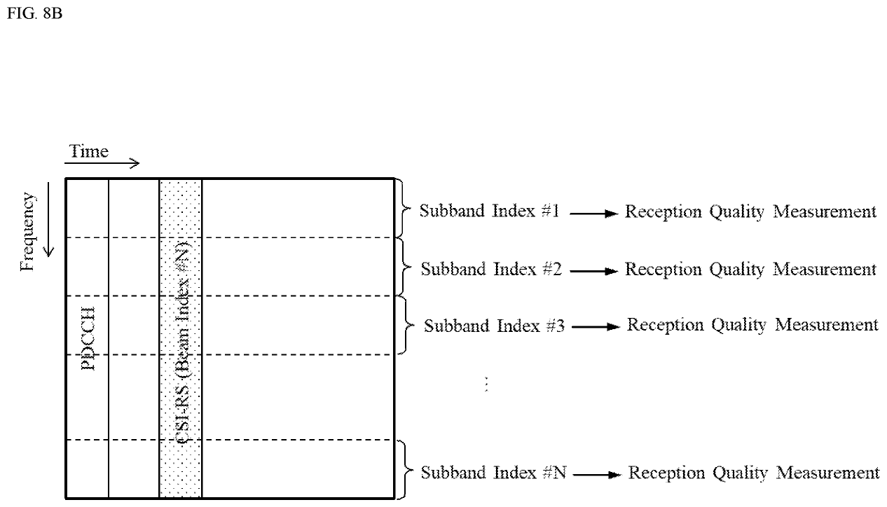

As shown in FIG. 7, at step S201, the gNB 20 may transmit multiple wideband CSI-RSs to the UE 10. The wideband CSI-RS is an example of a predetermined RS multiplexed on all frequency resources as shown in FIG. 2A. Each of the multiple wideband CSI-RSs (the first, second, third, . . . , and N-th CSI-RSs) in FIG. 7 has a resource configuration as shown in FIG. 2A. Thus, the first, second, third, . . . , and N-th CSI-RSs may be multiplexed on all of the subbands of subband indexes #1, #2, #3, . . . , and # N. In an example of FIG. 7, the first, second, third, . . . , and N-th CSI-RSs may be transmitted using beams of beam indexes #1, #2, #3, . . . , and # N, respectively. As shown in FIG. 8A, each of the CSI-RSs may be transmitted using the same resource. As another example, as shown FIG. 8B, each of the CSI-RSs may be transmitted using a different resource.

Then, the UE 10 receives the multiple wideband CSI-RSs. At step S202, the UE 10 may measure reception quality of the multiple wideband CSI-RSs. In an example of FIG. 8A, the reception quality of each subband in each of the wideband CSI-RSs may be measured.

At step S203, the UE 10 may select, from the subbands (subband indexes #1-# N), the subband (e.g., subband index #1) for which the best reception quality is measured in the multiple wideband CSI-RSs. Furthermore, the UE 10 may select the M subbands that may achieve the best-M reception quality.

At step S204, the UE 10 may transmit feedback information including the selected subband index (e.g., subband index #1) to the gNB 20. The feedback information may include at least one of the reception quality (e.g., RSRP) of the selected subband and the beam index corresponding to the selected subband.

In the CSI acquisition scheme, at step S205, the gNB 20 may transmit a subband CSI-RS multiplexed on the selected subband (e.g., subband index #1) to the UE 10.

When the UE 10 receives the subband CSI-RS, the UE 10 may perform the CSI calculation based on the subband CSI-RS. At step S206, the UE 10 may transmit CSI feedback based on the calculated CSI.

Thus, according to one or more embodiments of the second example of the present invention, the subband may be selected based on the reception quality measurement of the multiple wideband CSI-RSs. As a result, it is possible to determine the appropriate subband allocated to the subband CSI-RS in the CSI acquisition scheme efficiently.

### Second Modified Example

According to one or more embodiments of a second modified example of the present invention, a beam may be selected based on reception quality of wideband RSs and a subband allocated to a subband CSI-RS in the CSI acquisition scheme may be selected from subbands in the selected beam.

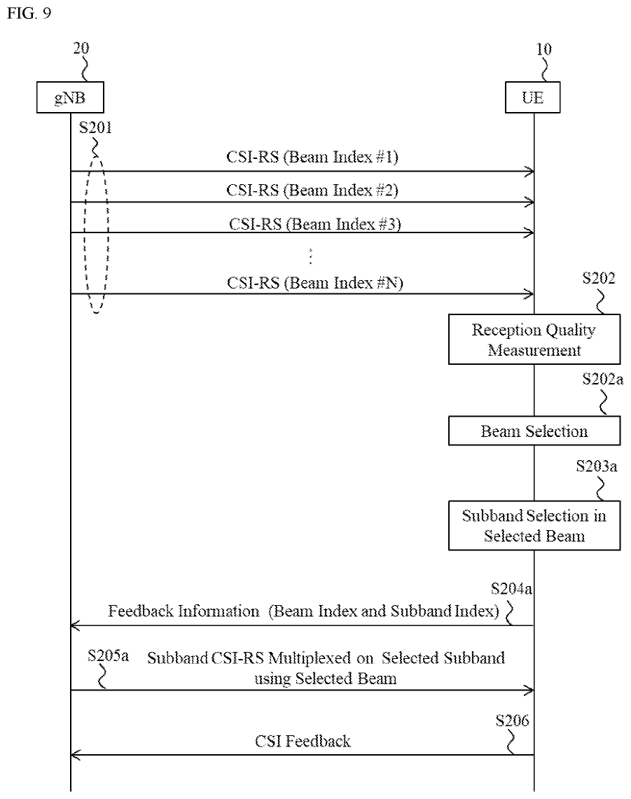

FIG. 7 is a sequence diagram showing an operation example of beam management and CSI acquisition schemes according to one or more embodiments of the second modified example of the present invention. Similar steps in FIG. 9 to steps in FIG. 7 may have the same reference labels.

As shown in FIG. 7, after the reception quality measurement at the step S202, the UE 10 may select, from the beams used for transmission of the CSI-RS, a beam (e.g., beam index #1) based on the reception quality of the wideband CSI-RSs at step S202a. For example, the UE 10 may select the beam used for transmission of the wideband CSI-RS having the best reception quality. As another example, the UE 10 may select the M beam used for transmission of the wideband CSI-RSs that may achieve the best-M reception quality.

At step S203a, the UE 10 may select, from the subbands (subband indexes #1-# N) in the selected beam (e.g., beam index #1), the subband (e.g., subband index #1) for which the best reception quality is measured. Furthermore, the UE 10 may select the best-M reception quality in the selected beam and select, from the subbands in the selected beam, the M subbands for which the best-M reception quality is measured.

At step S204a, the UE 10 may transmit feedback information including the selected beam index (e.g., beam index #1) and the selected subband index (e.g., subband index #1) to the gNB 20. The feedback information may include the reception quality (e.g., RSRP) of the selected subband.

In the CSI acquisition scheme, at step S205a, the gNB 20 may transmit a subband CSI-RS multiplexed on the selected subband (e.g., subband index #1) using the selected beam (e.g., beam index #1) to the UE 10.

At step S206, the UE 10 may transmit, to the gNB, the CSI feedback based on the calculated CSI using the subband CSI-RS.

Thus, according to one or more embodiments of the second modified example of the present invention, the subband may be selected from the subbands in the selected beam. As a result, it is possible to determine the appropriate subband allocated to the subband CSI-RS in the CSI acquisition scheme efficiently.

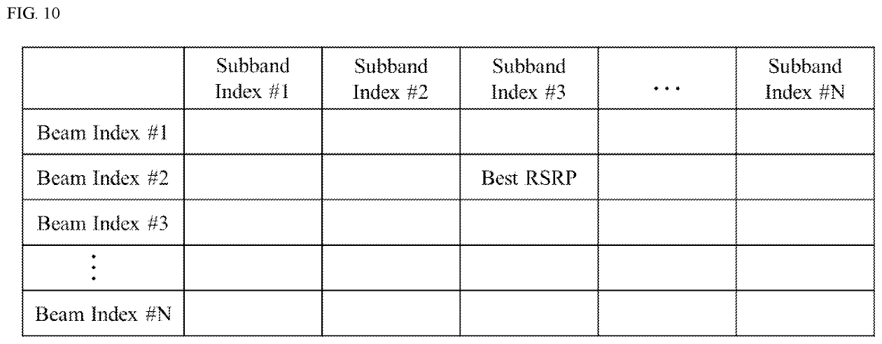

As another example, at step S202a in FIG. 9, the UE 10 may select the beam based on the reception quality in each of the subbands in the multiple CSI-RSs. For example, as shown in FIG. 10, when the subband of the subband index #3 corresponding to the beam of the beam index #2 has the best RSRP, the UE 10 may select the beam of the beam index #2. Then, the UE 10 may transmit the feedback information including the selected beam (e.g., beam index #2) and the selected subband (e.g., subband index #3) for which the best reception quality is measured.

### Third Example

According to one or more embodiments of a third example of the present invention, the UE 10 may transmit feedback information including beam information (e.g., beam index) in each subband to the gNB 20.

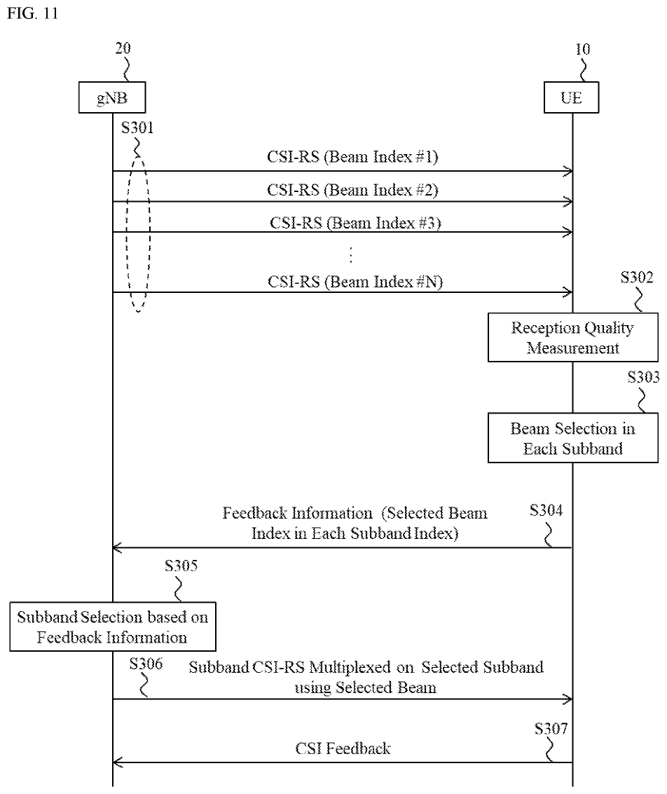

FIG. 11 is a sequence diagram showing an operation example of beam management and CSI acquisition schemes according to one or more embodiments of the third example of the present invention.

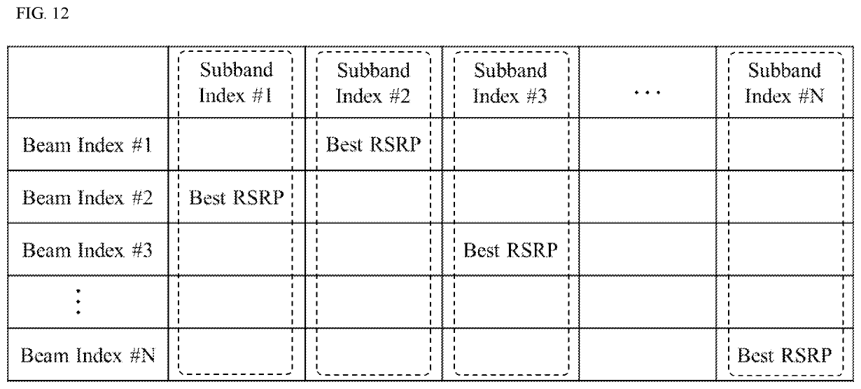

Steps S301 and S302 in FIG. 11 are similar to the steps S201 and S202 in FIG. 7. As shown in FIG. 11, at step S303, the UE 10 may select a beam in each of the subbands in the multiple wideband CSI-RSs. For example, as shown in FIG. 12, the beam having the best reception quality (RSRP) in each subband may be selected. For example, the beam indexes #2, #1, #3, and # N having the best RSRP may be selected in the subband indexes #1, #2, #3, and # N, respectively.

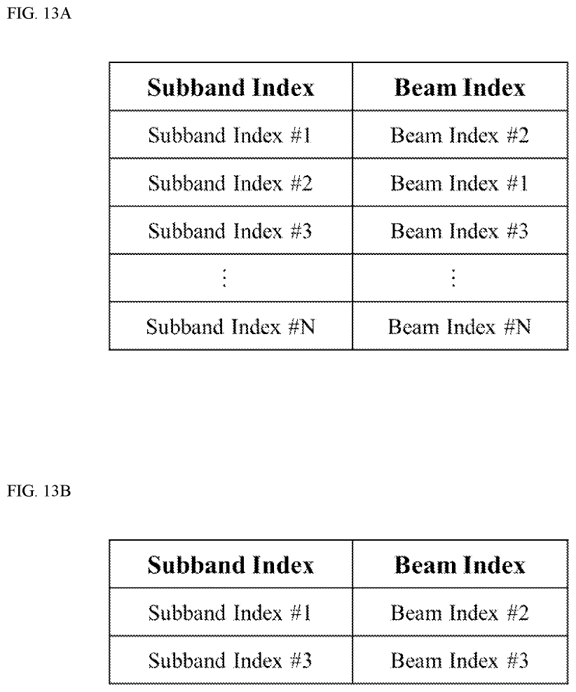

At step S304, the UE 10 may transmit, to the gNB 20, feedback information including the selected beam index in each subband as shown in FIG. 13A. The feedback information may include the reception quality (e.g., RSRP) of the selected beam. As another example, as shown in FIG. 13B, the feedback may be performed in part of the subband indexes. For example, the feedback information may include “M” combinations of the beams and the subbands that achieves the best-M RSRP (in an example of FIG. 13B, “M” is 2).

At step S305, the gNB 20 may select a subband allocated to the subband CSI-RS based on the feedback information. For example, when the feedback information includes the RSRP of the beams, the gNB 20 may select a beam having the best RSRP in the beams in the feedback information and select a subband corresponding the selected beam.

In the CSI acquisition scheme, at step S306, the gNB 20 may transmit a subband CSI-RS multiplexed on the selected subband using the selected beam to the UE 10.

At step S307, the UE 10 may transmit, to the gNB, the CSI feedback based on the calculated CSI using the subband CSI-RS.

Thus, according to one or more embodiments of the third example of the present invention, the UE 10 may transmit the feedback information including the selected beam in each subband and the gNB 20 may select the subband allocated to the subband CSI-RS in the CSI acquisition scheme efficiently.

### Third Modified Example

According to one or more embodiments of a third modified example of the present invention, the UE 10 may transmit feedback information including subband information (e.g., subband index) associated with beam information (e.g., beam index) to the gNB 20.

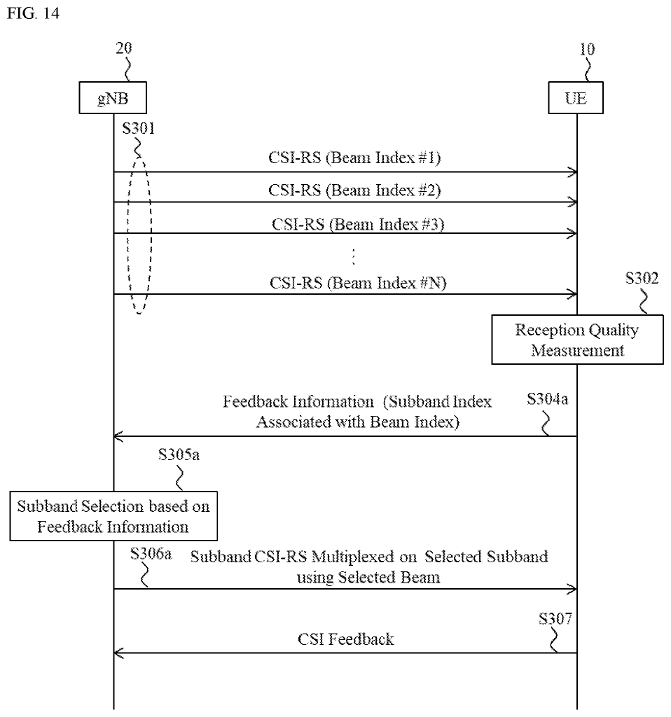

FIG. 14 is a sequence diagram showing an operation example of beam management and CSI acquisition schemes according to one or more embodiments of the third modified example of the present invention. Similar steps in FIG. 14 to steps in FIG. 11 may have the same reference labels.

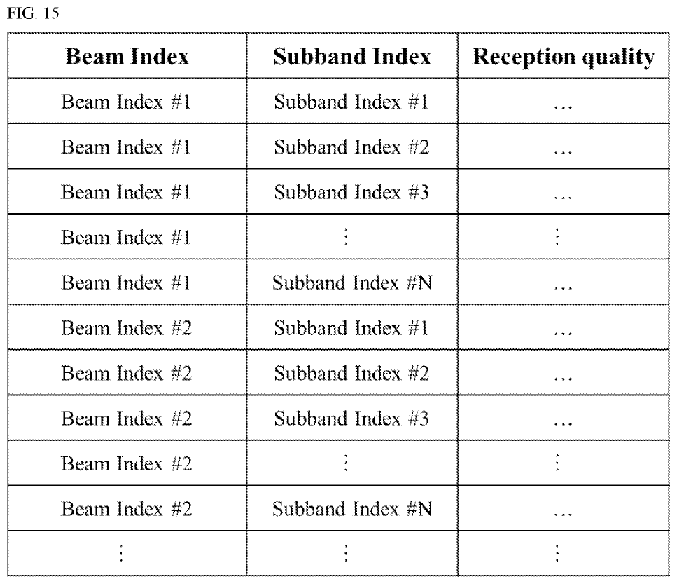

As shown in FIG. 14, after the reception quality measurement at the step S302, the UE 10 may transmit feedback information to the gNB 20. As shown in FIG. 15, the feedback information may include the subband index associated with the beam index and/or reception quality (e.g., RSRP). The number of pairs of the beam index and the subband index in the feedback information may be one or more.

In the CSI acquisition scheme, at step S305a, the gNB 20 may select a subband allocated to the subband CSI-RS based on the feedback information. For example, the gNB 20 may select the subband based on the reception quality in the feedback information.

### Another Example

In one or more embodiments of the first to third examples of the present invention, when the feedback information includes the RSRP, time-domain averaging may not be applied to the RSRP (L1-RSRP). As another example, in one or more embodiments of the first to third examples of the present invention, when the feedback information includes the RSRP, time-domain averaging may be applied to the RSRP (L3-RSRP).

In one or more embodiments of the first to third examples of the present invention, the RSRP may be calculated for each of the subbands.

In one or more embodiments of the present invention, the subband that is selected for beam management report may be selected by the UE 10 or the gNB 20.

The subband selection and the beam selection according to one or more embodiments of the first to third examples of the present invention may be used to improve characteristics of a desired signal and to decrease interference signals. In view of the above, the subbands and beams having the best-M reception quality (or worst-M reception quality) may be selected.

The aforementioned technologies according to one or more embodiments of the first to third examples of the present invention is not limited to the beam management scheme. The aforementioned technologies may be applied to a cell and beam selection scheme in initial access/mobility and the CSI acquisition scheme using a Synchronization Signal (SS).

(Configuration of gNB)

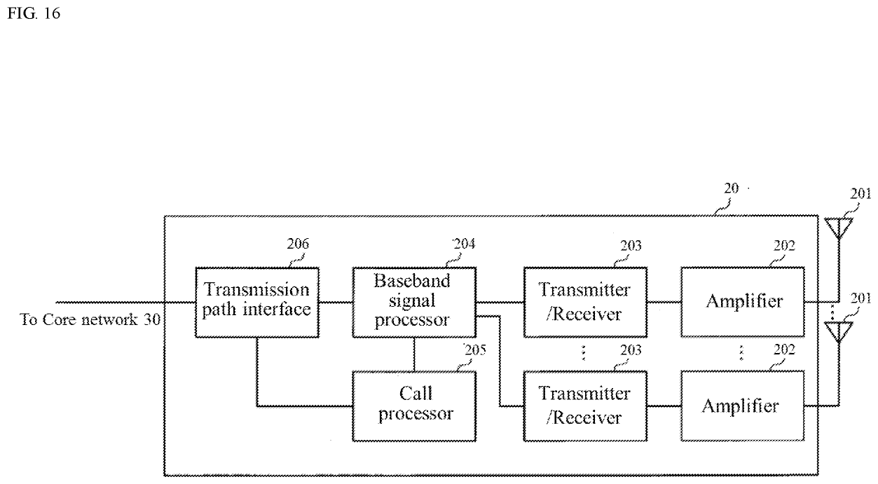

The gNB 20 according to one or more embodiments of the present invention will be described below with reference to FIG. 16. FIG. 16 is a diagram illustrating a schematic configuration of the gNB 20 according to one or more embodiments of the present invention. The gNB 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the gNB 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the gNB 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the gNB 20, and manages the radio resources.

(Configuration of User Equipment)

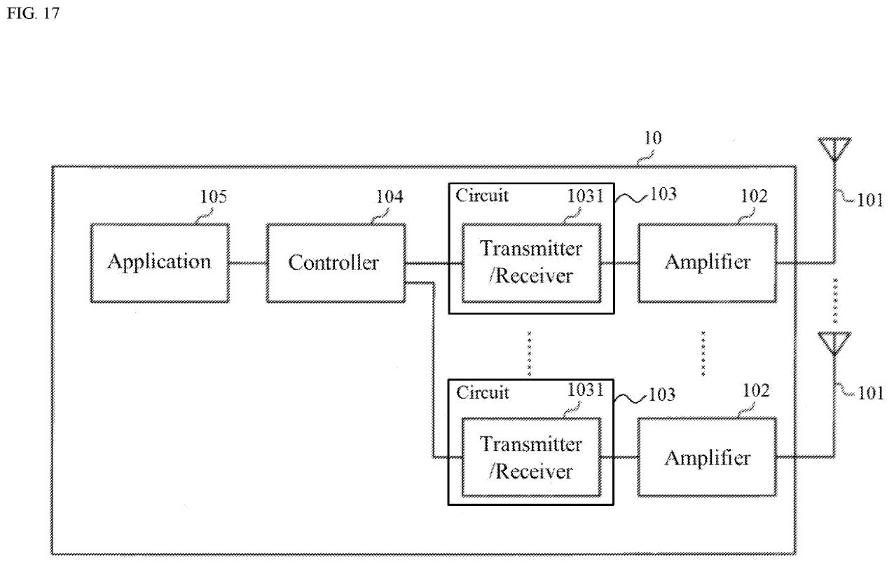

The UE 10 according to one or more embodiments of the present invention will be described below with reference to FIG. 17. FIG. 17 is a schematic configuration of the UE 10 according to one or more embodiments of the present invention. The UE 10 has a plurality of UE antenna S101, amplifiers 102, the circuit 103 comprising transceiver (transmitter/receiver) 1031, the controller 104, and an application 105.

As for DL, radio frequency signals received in the UE antenna S101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention may be applied to the uplink, downlink, transmission, and reception.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

Although the present disclosure mainly described examples of technologies related to channel estimation and CSI feedback schemes based on the CSI-RS, the present invention is not limited thereto. One or more embodiments of the present invention may apply to another synchronization signal, reference signal, and physical channel such as Primary Synchronization Signal/Secondary Synchronization Signal (PSS/SSS) and DM-RS.

Although the present disclosure described examples of various signaling methods, the signaling according to one or more embodiments of the present invention may be explicitly or implicitly performed.

Although the present disclosure mainly described examples of various signaling methods, the signaling according to one or more embodiments of the present invention may be higher layer signaling such as RRC signaling and/or lower layer signaling such as Down Link Control Information (DCI) and Media Access Control Control Element (MAC CE). Furthermore, the signaling according to one or more embodiments of the present invention may use a Master Information Block (MIB) and/or a System Information Block (SIB). For example, at least two of the RRC, the DCI, and the MAC CE may be used in combination as the signaling according to one or more embodiments of the present invention.

According to one or more embodiments of the present invention, whether the physical signal/channel is beamformed may be transparent for the UE. The beamformed RS and the beamformed signal may be called the RS and the signal, respectively. Furthermore, the beamformed RS may be referred to as a RS resource. Furthermore, the beam selection may be referred to as resource selection. Furthermore, the Beam Index may be referred to as a resource index (indicator) or an antenna port index.

One or more embodiments of the present invention may be applied to CSI acquisition, channel sounding, beam management, and other beam control schemes.

In one or more embodiments of the present invention, the frequency (frequency-domain) resource, a Resource Block (RB), and a subcarrier in the present disclosure may be replaced with each other. The time (time-domain) resource, a subframe, a symbol, and a slot may be replaced with each other.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method for wireless communication, the method comprising:
transmitting, from a base station (BS) to a user equipment (UE), multiple Channel State Information Reference Signals (CSI-RSs) multiplexed on different subbands;
selecting, with the UE, a predetermined subband of the different subbands based on reception quality of the multiple CSI-RSs; and
transmitting, form the UE to the BS, information indicating the predetermined subband.

2. The method according to claim 1, wherein the predetermined subband is allocated to a CSI-RS having best reception quality of the multiple CSI-RSs.

3. The method according to claim 1, further comprising:
transmitting, from the BS to the UE, a CSI-RS multiplexed on the predetermined subband; and
transmitting, from the UE to the BS, CSI feedback based on the CSI-RS multiplexed on the predetermined subband.

4. The method according to claim 1, further comprising:
measuring, with the UE, the reception quality of the multiple CSI-RSs.

5. A method for wireless communication, the method comprising:
transmitting, from a base station (BS) to a user equipment (UE), multiple Channel State Information Reference Signals (CSI-RSs), wherein each of the multiple CSI RSs is multiplexed on a wideband that includes a plurality of subbands;
measuring, with the UE, reception quality of the multiple CSI-RSs in each of the plurality of subbands;
selecting, with the UE, a predetermined subband of the plurality of subbands based on the reception quality; and
transmitting, form the UE to the BS, information indicating the predetermined subband.

6. The method according to claim 5, wherein the selecting selects the predetermined subband of the plurality of subbands of the multiple CSI-RSs.

7. The method according to claim 5, further comprising:
transmitting, from the BS to the UE, a CSI-RS multiplexed on the predetermined subband; and
transmitting, from the UE to the BS, CSI feedback based on the CSI-RS multiplexed on the predetermined subband.

8. The method according to claim 5,
wherein the transmitting transmits the multiple CSI-RSs using different beams,
the method further comprising:
determining, with the UE, a predetermined beam of the different beams based on the reception quality,
wherein the selecting selects the predetermined subband allocated to the CSI-RS that is transmitted using the predetermined beam.

9. The method according to claim 8, wherein the information indicates the predetermined beam.

10. The method according to claim 8, wherein the information indicates the reception quality corresponding the predetermined subband.

11. A method for wireless communication, the method comprising:
transmitting, from a base station (BS) to a user equipment (UE), multiple Channel State Information Reference Signals (CSI-RSs) using different beams, wherein each of the multiple CSI RSs is multiplexed on a wideband that includes a plurality of subbands;
measuring, with the UE, reception quality of the multiple CSI-RSs in each of the plurality of subbands;
determining, with the UE, a predetermined beam of the different beams in each of the plurality of subbands based on the reception quality; and
transmitting, form the UE to the BS, information indicating the predetermined beam in each of the plurality of subband.

12. The method according to claim 11, wherein the information indicates the reception quality corresponding the predetermined subband.

13. The method according to claim 11, further comprising:
selecting, with the BS, a predetermined subband based on the information;
transmitting, from the BS to the UE, a CSI-RS multiplexed on the predetermined subband; and
transmitting, from the UE to the BS, CSI feedback based on the CSI-RS multiplexed on the predetermined subband.
